(19) United States
(12) Patent Application Publication
(10) Pub. No.: US 2011/0137820 A1
(43) Pub. Date: Jun. 9, 2011

(54) GRAPHICAL MODEL-BASED DEBUGGING FOR BUSINESS PROCESSES

(76) Inventors: Julia REISBICH, Leimen (DE); Soeren BALKO, Weinheim (DE); Reiner HILLE-DOERING, Karlsruhe (DE)

(21) Appl. No.: 12/633,838

(22) Filed: Dec. 9, 2009

(51) Int. Cl. G06Q 10/00; G06F 3/048

(52) U.S. Cl. 705/348; 715/764

(57) ABSTRACT

A system and method to for debugging a business process in a GUI are described. In various embodiments, breakpoints are attached to business process elements and business process context parameters are received after a breakpoint is reached. In various embodiments, commands are provided to navigate through a business process and explore elements of the business process. In various embodiments, temporary breakpoints are created to service some of the commands.

### TECHNICAL FIELD

The invention relates generally to debugging of business processes, and more specifically, to model-based debugging of a business process in a graphical user interface.

### BACKGROUND

End users modeling a business process with a business process modeling tool during design time and executing it at runtime may not have the ability to analyze the data flow and control flow during each step of a business process before the business process may be used productively.

End users modeling a business process may require operational data, which is not available at design time and can have difficulties in analyzing a productive business process because a productive environment may differ from a test landscape used in design time.

Business process modeling is error-prone because typically process notations represent a complex programming model having a Turing-complete expressiveness. For example, the data resulting from the execution of a business process may not be as expected by the user or, it might reach an error state.

To identify problems with the execution of the business process, a user may have to manually analyze each business process step by exploring the business process model and tracing a process run from a recorded process log; and also associating events listed therein to a particular process step and steps preceding the particular process step which elements may have caused the problems.

Further, there may be a need to understand a typical process run and any implications of model elements. A user may need to determine if a model of a business process is functionally correct.

Such analysis can be very time-consuming and error-prone especially when a complex model has to be analyzed.

### SUMMARY

These and other benefits and features of embodiments of the invention will be apparent upon consideration of the following detailed description of preferred embodiments thereof, presented in connection with the following drawings.

A system and method to debug a business process in a graphical environment are described. In various embodiments, a number of breakpoints are set on a business process model and attached to a deployed business process. The deployed business process is executed to examine business process context information at the breakpoints. Upon an occurrence of a breakpoint, business process context information is sent to a graphical user interface.

In various embodiments, a method of the embodiments performs stepping operations and changing a business process context.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a flow diagram of an embodiment for debugging of a business process.

FIG. 2 is a flow diagram of an embodiment for initiating a debugging of a business process.

FIG. 3 is an exemplary sequence diagram of an embodiment for initiating a debugging of a business process.

FIG. 4 is a flow diagram of an embodiment for attaching breakpoints to a business process.

FIG. 5 is an exemplary sequence diagram of an embodiment for attaching breakpoints to a business process.

FIG. 6 is a flow diagram of an embodiment for sending business process context information to a graphical user interface (GUI).

FIG. 7 is an exemplary sequence diagram of an embodiment for sending business process context information to a GUI.

FIG. 8 is a flow diagram of an embodiment for terminating a debugging of a business process.

FIG. 9 is an exemplary sequence diagram of an embodiment for terminating a debugging of a business process.

FIG. 10 is a flow diagram of an embodiment for examining a set of input data for a step in a business process.

FIG. 11 is a flow diagram of an embodiment for examining a set of output data for a step in a business process.

FIG. 12 is a block diagram of a system of an embodiment for debugging a business process.

FIG. 13 is a block diagram of an exemplary computer system of an embodiment.

### DETAILED DESCRIPTION

Embodiments of techniques for graphical model-based debugging for business processes are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

A business process describes an execution of a business goal as receiving a set of inputs, manipulating the received inputs, and producing a set of outputs. Business processes may form complex interaction patterns with other processes; and thus, can have side effects on the operations of other processes and may also be manipulated by other processes. A business process represents a set of activities describing a fulfillment of a business task or a collection of business tasks in a specific order. The set of activities in the specific order are also referred to as business process steps. The business process steps describe the flow of data within the business process. The order, in which the business process steps are executed in, may also be referred to as “control flow” or “business process control flow”. The manner, in which data may be manipulated in a business process, may also be referred to as “data flow” or “business process data flow”. A business process context is a set of variables that may be required in the execution of a business process. A business process context also represents the status of the business goal behind the business process. Some variables in the business process context may have attributes and others may not. Some attributes of the variables related to the context of the business process may represent name-value pairs of data.

Business processes are typically expressed in graphical models to enable professionals with little or no technical knowledge to model business processes in information technology landscapes.

A business process may include, but is not limited to, activity elements, event elements, sub-process elements, tasks, gateways, data objects, control flow connectors, and other elements.

Event elements describe “something that happens.” A “start event” acts as a trigger for a business process. An “end event” represents the result of a business process. An “intermediate event” represents something that happens between the start and end events. An intermediate event may synchronize the business process with external stimuli.

An activity describes the kind of work which is to be performed, and, generally, an atomic unit of work.

A task represents a single unit of work. Tasks may also represent human interactions (as opposed to other activities which may represent automated interactions with other business systems or business processes).

A sub-process is used to hide or reveal additional levels of business process detail. A sub-process may have its own start and end events. A sub-process is a scoping concept in a business process and represents a business process collapsed to a reusable block.

A business process step typically requires data to run. Such data may be provided to the business process step via an input mapping. An input mapping describes how data related to the execution of a business process step is obtained from a business process context. An output mapping describes how data resulting from the execution of the process step is provided back to the business process context.

A business process may be modeled so that the control flow of the business process ensures the satisfaction of a number of requirements related to the business goal represented by the business process, such as, but not limited to, efficiency, timeliness, quality of service, resource consumption, and any Service Level Agreements (SLAs).

Within an organization, business processes may be modeled by business process experts who may have thorough knowledge of the particular business of the organization, a particular business process, the desired deliverables of a business process, and any requirements for the business process. Business processes may be modeled in Graphical User Interfaces (“GUIs”) or in text-based environments. Business processes are typically modeled using business process modeling languages. Business Process Modeling Notation (“BPMN”) is one such example. BPMN provides a graphical notation to model business processes. It however should be noted that embodiments described herein may be used to debug business processes modeled with any number of different modeling languages, both text-based and graphical.

In one embodiment, a business process may be modeled on a client GUI (also referred to as “design time environment”) and executed on a server runtime environment. In one embodiment, the GUI client and the server runtime may be deployed and executed on a number of separate machines. In another embodiment, the client GUI and the server runtime may be deployed and executed on the same machine.

After the creation of a business process, it may be necessary to examine the execution of the business process, the data flow, the input and output mappings, and the process context on one or more business process steps. Such an examination may be necessary, for example, to ensure that the business process control flow meets expected requirements, to ensure that the business process data flow is modeled to correctly reflect the manipulation of data involved, and to recognize any errors that may occur during the execution of the business process. If needed, the business process can be debugged. Also, business process context information may need to be presented via a GUI for the benefit of a business process expert. Thus, the analysis of the business process may happen in the design time environment which is where the business process is modeled so that an end user does not need to be familiar with a productive environment. For example, the content of the business process content may be relevant for the state of the business process at a point in the execution of the business process. For example, the business process context may hold data resulting from a step in the business process. Thus, by examining the data resulting from the step, a business process expert may determine if the business process executed as expected.

Debugging involves setting breakpoints where the business process is suspended and information is collected. A breakpoint is a way to forcefully suspend a business process run at a specific step and allow for inspecting the business process context at this particular step. In debugging a process, a user may decide to initially define a number of breakpoints, thus forcing the process to stop at these locations.

In various embodiments, temporary breakpoints may also be set. Temporary breakpoints may be set automatically by a system without the need for user intervention. A temporary breakpoint is automatically deleted when it is reached; thus, temporary breakpoints can be useful to implement stepping functionality because a process run is suspended once at a temporary breakpoint (e.g., if a user steps to the model element where the temporary breakpoint is).

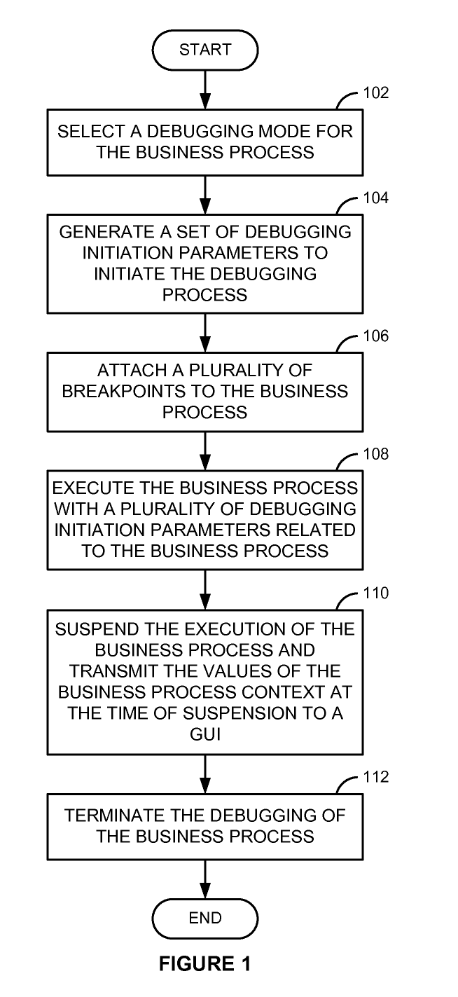

In various embodiments, a business process is created in a graphical user interface (“GUI”) and debugged in the GUI. FIG. 1 is a flow diagram of an embodiment for debugging a business process. Referring to FIG. 1, at process block 102, a debugging mode is selected for the business process. In one exemplary embodiment, a system of an embodiment may provide various modes of debugging including a mode to debug a particular instance of a business process, a mode to debug an arbitrary instance of a business process, and a mode to debug a number of or all instances of a business process.

At process block 104, a set of debugging initiation parameters are generated to initiate the debugging of the business process. At process block 106, one or more breakpoints are attached to the business process. In debugging a process, a user may decide to initially define a number of breakpoints, thus forcing the process to stop at these locations.

In one embodiment, the one or more breakpoints are created via graphical tools in the GUI. A breakpoint represents a point in the process execution where process execution is interrupted to examine the business process context of the business process at that point. The parameters in the process context reflect the information that can be retrieved for the business process at a given point in the execution of the business process. The values of the business process parameters represent the state of the business process context at that point in the execution of the business process. For example, a step in a business process may require data; then the step in the business process may process the data and produce some resulting data. Thus, before the step in the business process is executed and after the step in the business process is executed, the parameter values in the business process context may hold different data. By examining the data before the step and after the step, it may be determined whether the business process executes as expected. For instance, a business process may be expected to produce deliverables per a unit of time. By examining the data in the business process context it may be determined whether the business process produces the expected number of deliverables for the expected unit of time.

At process block 108, the business process is executed with the debugging initiation parameters. At process block 110, the execution of the business process is suspended and the values of a number of business process context parameters at the time of the suspension are sent to the GUI. The context parameters are sent after a breakpoint is reached. After the breakpoint is reached, the business process execution is suspended and the values of the context parameters at that point in the execution are sent to the GUI. At process block 112, the debugging is terminated. The debugging of the business process may be terminated either at the end of the business process execution or after the last breakpoint attached to the business process. In various embodiments, a debugging of a business process may be terminated by a user via tools in the design time environment.

In one embodiment, the execution of the business process may be iteratively resumed and interrupted until context information is displayed in the GUI client about each of the number of created breakpoints.

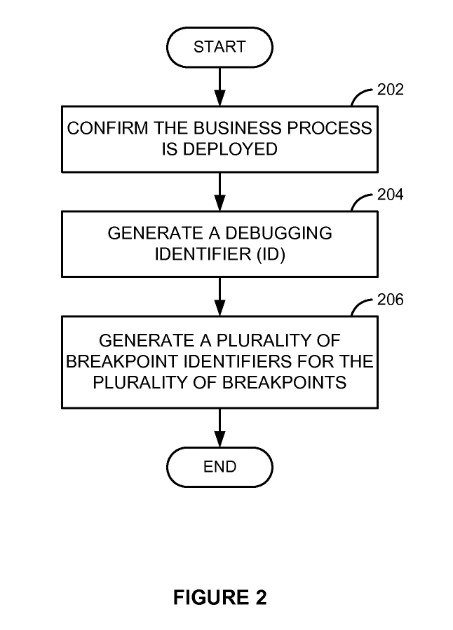

FIG. 2 is a flow diagram of an embodiment for initiating a debugging of a business process. Referring to FIG. 2, at process block 202, it is confirmed that the business process to be debugged is deployed. To debug the business process, the business process must be executed and to execute the business process, the business process must be deployed beforehand. As used herein, “deployed” refers to an operation where a business process is available in a business process runtime environment and can be executed.

At process block 204, a debugging identifier (ID) is generated. The debugging identifier is used to differentiate the debugging session from other debugging sessions that may be performed simultaneously. Also, more than one instance of the same business process may be debugged, depending on the selection of available debugging modes. Thus, the debugging ID may serve to identify debugging sessions and business process instances thereof. At process block 206, a number of breakpoint IDs are generated for the received number of breakpoints. The breakpoint IDs are used to relate debugging operations to a particular breakpoint instance.

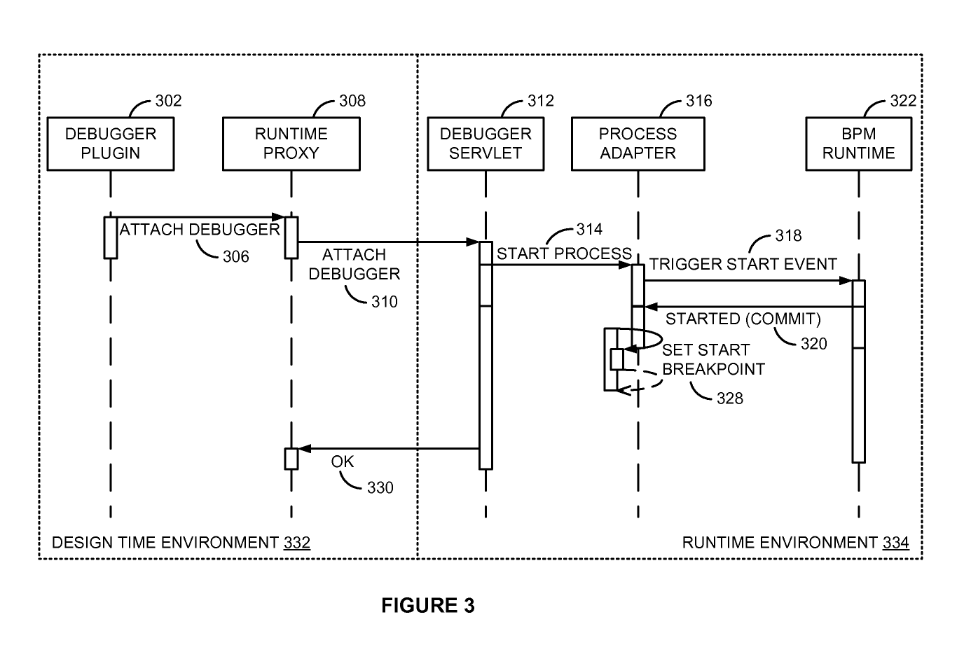

In one embodiment, the process as described in FIG. 2 is executed in an exemplary system via the exemplary method calls as described in FIG. 3. Referring to FIG. 3, at block 306, the debugger plugin 302 initiates the debugging with an “attach debugger” method call to the runtime proxy 308. At block 310, the runtime proxy 308 sends the “attach debugger” method call to the debugger servlet 312. The debugger servlet 312 sends a “start process” method call to the process adapter 316 at block 314. The process adapter 316 creates a “trigger start event” method call to the BPM runtime 322 at block 318. At block 320, the BPM runtime 322 confirms the start with a “started (commit)” message. The BPM runtime 322 instantiates the business process context. At block 328, the process adapter 316 sets a starting breakpoint with a “set start breakpoint” method call. At block 330, the debugger servlet 312 confirms the initiation of the debugging of the business process with an “OK” message to the runtime proxy 308 and passes back the debugging session ID and business process ID. In various embodiments, FIG. 3 may refer to a process performed partly in a design time environment 332 and partly in a runtime environment 334.

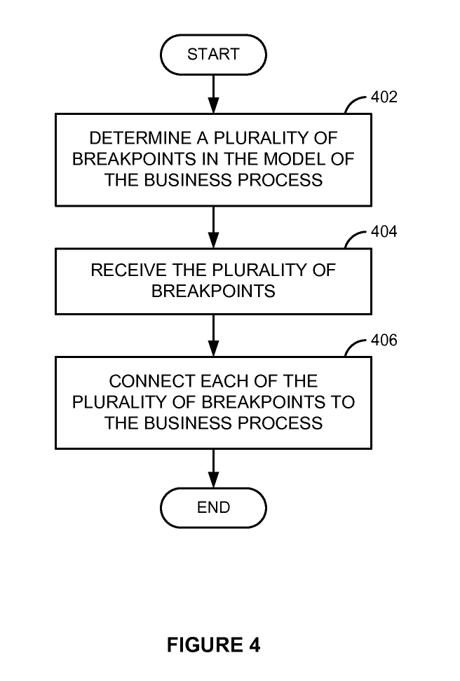

FIG. 4 is a flow diagram of an embodiment for attaching breakpoints to a business process. Referring to FIG. 4, at process block 402, a number of breakpoints are determined on the business process model. In one embodiment, the number of breakpoints may be determined in the GUI by a user via graphical tools in the GUI. In another embodiment, the breakpoints may be determined by the system to perform the debugging of the business process (for example, if stepping through a process is performed, breakpoints are set by a system on successor flow elements). The breakpoints designate elements of the business process that need examination and where a business process instance will be suspended and the design time environment will be notified. The elements of the business process may be examined to determine if an element receives input as expected and whether an element produces output as expected. Also, there may be an analysis of whether an element in a business process is reached at all. Thus, it may be determined if the business process will execute as expected at runtime. At process block 404, the breakpoints are received. At process block 406, each breakpoint is associated with an element of the business process. At this process block, the breakpoints determined on the business process model and received are connected to the corresponding elements in the deployed process so that when the process executes, the system may know where and when to suspend the business process execution and provide business process context information.

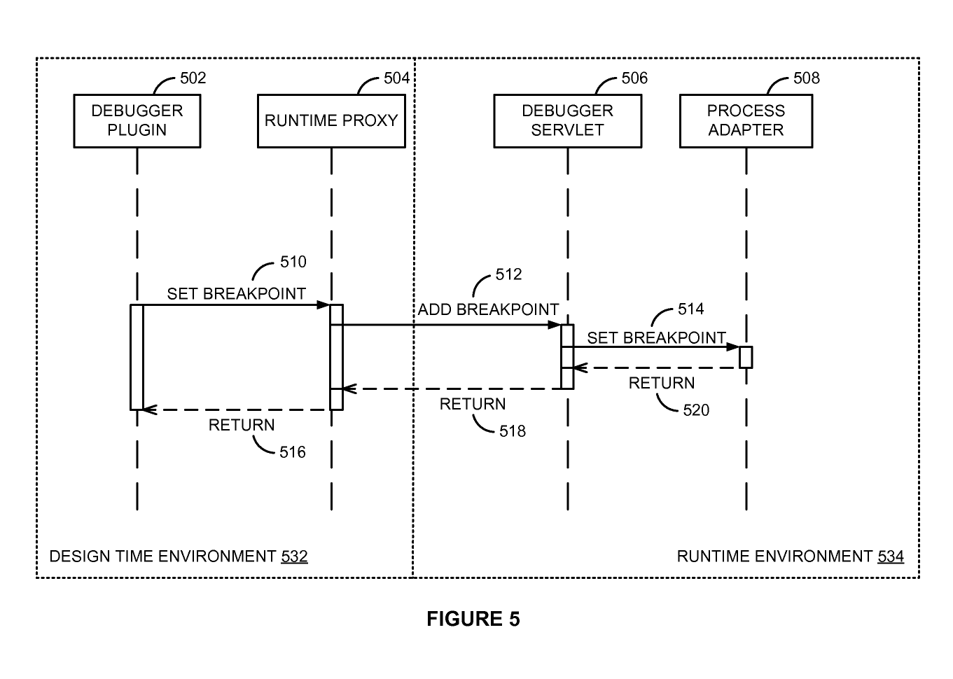

In one embodiment, the process as described in FIG. 4 is executed in an exemplary system via the exemplary method calls as described in FIG. 5. Breakpoints are added to a business process model in a design time environment and to take part in a debugging of a business process, the breakpoints are transported to a runtime environment and each breakpoint is associated with an element of the executable business process in the runtime environment. Referring to FIG. 5, at block 510, the debugger plugin 502 starts attaching a first received breakpoint with a “set breakpoint” method call to the runtime proxy 504. The runtime proxy 504 creates an “add breakpoint” call to the debugger servlet 506 at block 512. The debugger servlet 506 creates a “set breakpoint” call to the process adapter 508 at block 514. Thus, after block 514, the breakpoint is attached to the deployed business process. At block 520, the process adapter 508 confirms the breakpoint is attached with a “return” method call to the debugger servlet 506. The debugger servlet 506 confirms to the runtime proxy 504 with a “return” call at block 518. The runtime proxy 504 confirms to the debugger plugin 502 with a “return” method call at block 516. In various embodiments, the steps as described in blocks 510 through 516 may be iteratively repeated until all received breakpoints are attached to the deployed business process. In various embodiments, FIG. 5 may refer to a process performed partly in a design time environment 532 and partly in a runtime environment 534.

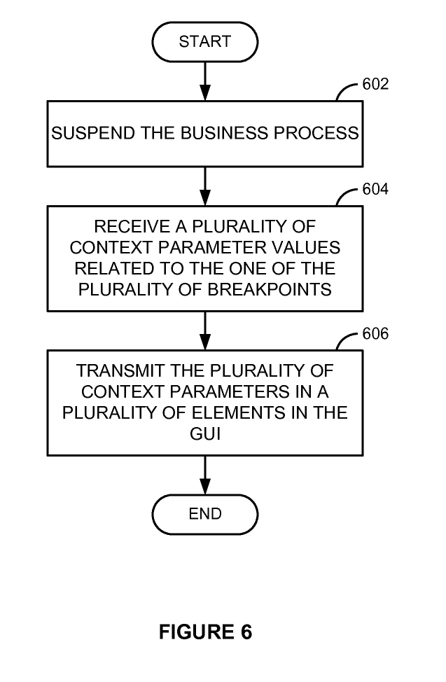

FIG. 6 is a flow diagram of an embodiment for sending business process context information related to the business process to a GUI. Referring to FIG. 6, at process block 602, a business process is suspended. A business process is suspended when a breakpoint is reached. The business process is suspended to allow for the collection of information from the business process context. Also, other user interactions can be performed. For example, while a business process is suspended, information from the business process context may be collected. Also, information from user interactions may be collected, such as, step into, step over, and so on.

At process block 604, business process context information related to the business process is received. The business process context information is represented by business process parameters and their corresponding values at the breakpoint when execution is suspended. At process block 606, the business process context parameter values are transmitted to graphical elements in the GUI.

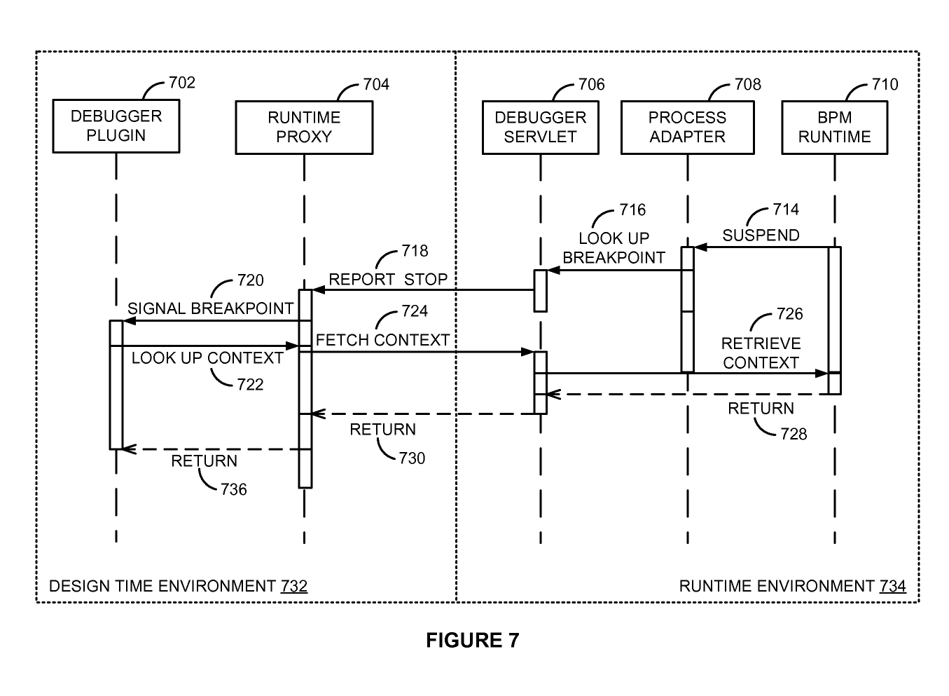

In one exemplary embodiment, the process as described in FIG. 6 is executed by a system and the methods as described in FIG. 7. Referring to FIG. 7, at block 714, the BPM runtime 710 suspends the business process execution after a breakpoint is reached with a “suspend” call to the process adapter 708. At block 716, the process adapter 708 creates a “look up breakpoint” call to the debugger servlet 706 to determine whether a breakpoint is associated with the element that is currently processed. The debugger servlet 706 reports the suspension of the business process to the runtime proxy 704 with a “report stop” call at block 718. At block 720, the runtime proxy 704 notifies the debugger plugin 702 of the occurrence of a breakpoint with a “signal breakpoint” method call to the debugger plugin 702. The debugger plugin 702 initiates the retrieval of business process context information with a “look up context” call to the runtime proxy 704 at block 722. The runtime proxy 704 attempts to obtain the business process context with a “fetch context” method call to the debugger servlet 706 at block 724. The debugger servlet 706 obtains the business process context with a “retrieve context” call to the BPM Runtime 710 at block 726. The BPM Runtime 710 returns the business process context with a “return” call to the debugger servlet 706 at block 728. At block 730, the debugger servlet 706 sends the business process context information to the runtime proxy 704 with a “return” method call. At block 736, the runtime proxy 704 sends the business process context information to the debugger plugin 702 with a “return” call. In various embodiments, FIG. 7 may refer to a process performed partly in a design time environment 732 and partly in a runtime environment 734.

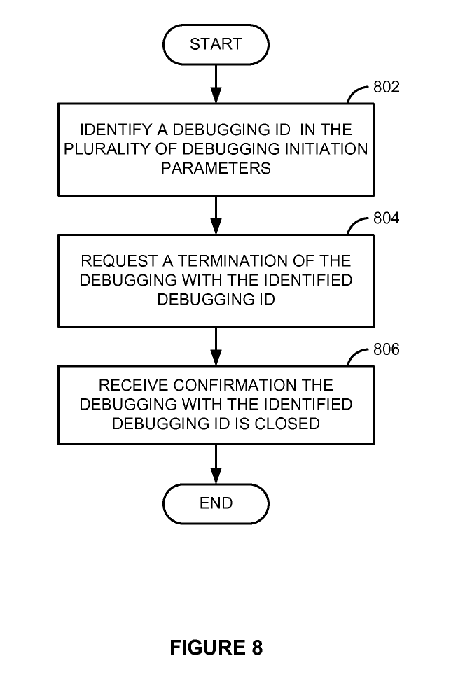

FIG. 8 is a flow diagram of an embodiment for terminating a debugging of a business process. Referring to FIG. 8, at process block 802, a debugging ID related to the business process is identified. At process block 804, a termination of the debugging with the identified ID is requested. At process block 806, a confirmation is received that the debugging with the identified ID is terminated. In various embodiments, a business process may also be implicitly terminated following system events such as, but not limited to, system or application shutdown, connection timeouts, network timeouts, and others.

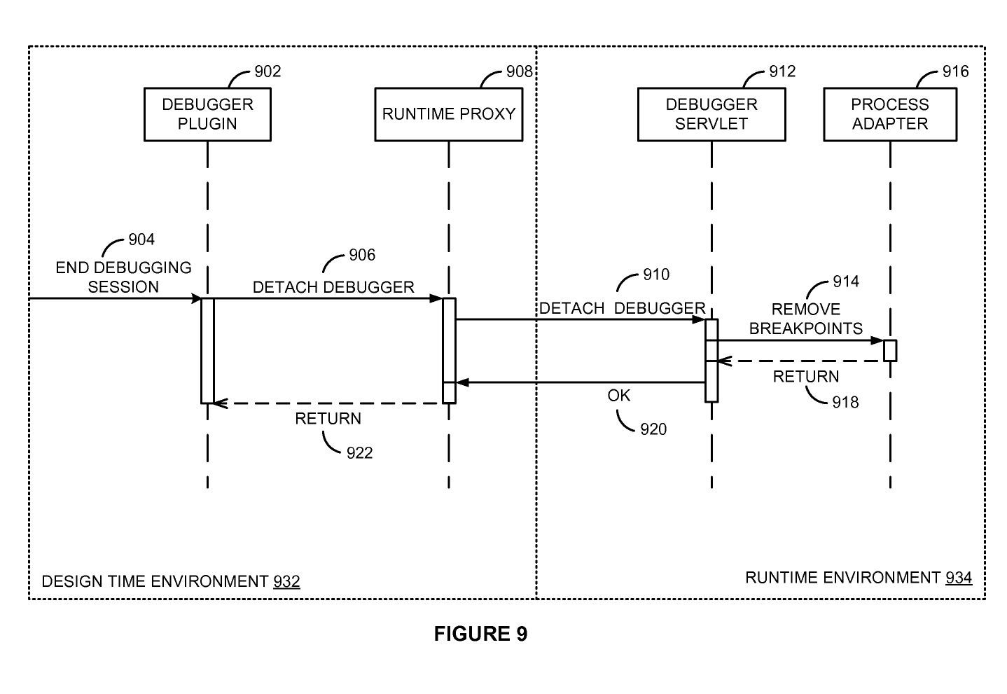

In one exemplary embodiment, the process as described in FIG. 8 is executed by the system and the methods in the exemplary FIG. 9. FIG. 9 is an exemplary sequence diagram of a method to terminate a debugging of a business process. Referring to FIG. 9, at block 904, the debugger plugin 902 initiates the stopping of the debugging session with an “end debugging session” method call. At block 906, the debugger plugin 902 sends a “detach debugger” method call to the runtime proxy 908. The runtime proxy 908 sends the “detach debugger” method call to the debugger servlet 912 at block 910. At block 914, the debugger servlet 912 instructs the process adapter 916 to remove any remaining breakpoints from the business process. The process adapter 916 confirms the removal at block 918 with a “return” method call to the debugger servlet 912. The debugger servlet 912 confirms with an “OK” message to the runtime proxy 908 at block 920. The runtime proxy 908 then confirms the termination of the debugging of the business process to the debugger plugin 902 at block 922 with a “return” method call. In various embodiments, FIG. 9 may refer to a process performed partly in a design time environment 932 and partly in a runtime environment 934.

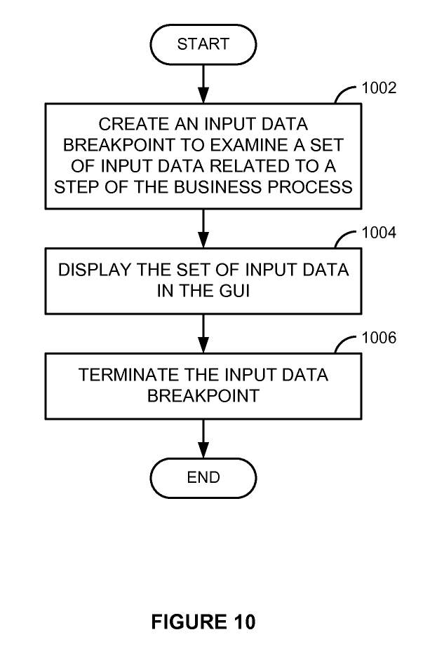

FIG. 10 is a flow diagram of an embodiment for examining a set of input data for a step in a business process. Referring to FIG. 10, at process block 1002, an input data breakpoint is created to examine the set of input data for the step of the business process. This input data breakpoint may or may not be part of an initial set of breakpoints generated before the start of the debugging of the business process and may be created on demand in response of a user or system request.

At process block 1004, the set of input data is displayed in the GUI. At process block 1006, the input data breakpoint is removed. The input data breakpoint is removed because there is no need to keep the breakpoint in the system after the input data for the process step of the business process has been examined. In this manner, system resources may be allocated if and when needed.

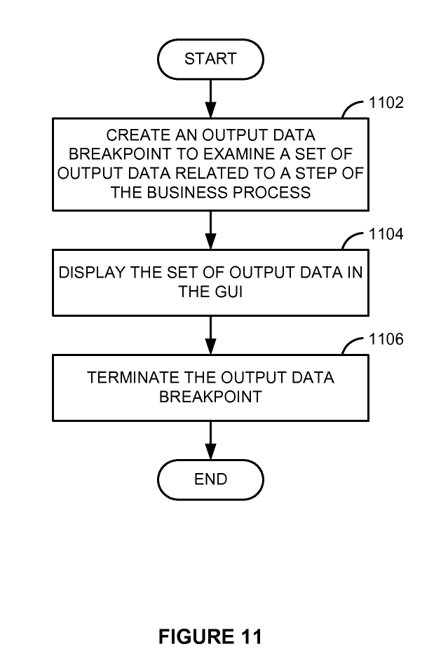

FIG. 11 is a flow diagram of an embodiment for examining a set of output data for a step in a business process. Output data is available when a process step is almost complete, that is, the process step has generated the output data. Thus, a breakpoint to fetch output data is triggered at point in the lifecycle of the process step before the step is completed. Referring to FIG. 11, at process block 1102, an output data breakpoint is created to examine the set of output data for the step of the business process. This output data breakpoint may or may not be part of an initial set of breakpoints generated before the start of the debugging of the business process and may be created on demand in response to a user or server request. At process block 1104, the set of output data is displayed in the GUI. At process block 1106, the output data breakpoint is removed.

In various embodiments, a system may provide a number of commands to examine the lifecycle of debuggable objects (e.g., model elements) of a business process and the input and output data related to debuggable objects. Using such commands, a user may navigate through the flow of a business process and choose which elements in a business process to explore and examine. In such a case, the system may create breakpoints on demand to respond to such commands. The debuggable objects (e.g., elements) in this exemplary embodiment include activities, events, sub-processes, gateways, and tasks.

Event elements describe “something that happens.” A “start event” acts as a trigger for a business process. An “end event” represents the result of a business process. An “intermediate event” represents something that happens between the start and end events.

An activity describes the kind of work which is to be performed.

A task represents a single unit of work.

A sub-process is used to hide or reveal additional levels of business process detail. A sub-process may have its own start and end events.

The activity elements of a business process may have the following two stages in their lifecycle: ‘on activation’ and ‘on completion’. The event elements of the business process may have the following two stages in their lifecycle: ‘on activation’ and ‘on completion’. The system of the embodiment may provide commands for a user to step through a business process and explore input and output mapping data, for an element depending on the point of execution of the business process and the lifecycle stage of the element at that point. Because each category of business process elements, e.g., event, activity, and sub-process represents an element of a specific nature, not all commands may be available for all categories of business process elements.

The user may select a ‘step into’ command to explore a sub-process of the business process.

The user may select a ‘step over’ command to direct the debugging to a subsequent debuggable object. The step over command may be chosen if a user does not wish to examine the input or output mapping of an element.

The user may select a ‘step return’ command to leave a sub-process and continue debugging a parent element.

Via the stepping commands, a user may navigate the debugging process and may choose to receive information with a greater granularity for a number of debuggable objects. For example, a user may wish to examine a business process, and then examine each sub-process of a business process in greater granularity.

As each step in the business process (e.g. debuggable object) receives data via an input mapping and delivers resulting data via an output mapping, the data displayed in the GUI depends on the user selected command and on the lifecycle stage the element is in.

Table 1 below describes the effect of selecting each of three commands (step into, step over and step return) on an activity of the business process depending on whether the command reaches the activity at the point before input mapping or in the stage after output mapping.

TABLE 1

| Activity | Step Into | Step Over | Step Return |
|---|---|---|---|
| Response to command | If the step into command | If the step over command | If the step return command |
| depending on element and | is chosen on an activity | is chosen on an activity | is chosen on an activity |
| point of execution of | element which is at the | element which is at the | element which is at the |
| the business process. | point before input | point before input | point before input |
| | mapping, the same element | mapping, the execution of | mapping, the execution of |
| | will be explored. | the business process will | the business process will |
| | | be resumed and suspended | be resumed and suspended |
| | | on the next element at the | on the next element at the |
| | | point before input | point before input |
| | | mapping. | mapping. |
| Response to command | If the step into command | If the step over command | If the step return command |
| depending on element and | is chosen on an activity | is chosen on an activity | is chosen on an activity |
| point of execution of | element which is at the | element which is at the | element which is at the |
| the business process. | point after output | point after output | point after output |
| | mapping, the next element | mapping, the next element | mapping, the next element |
| | will be explored at the | will be explored at the | will be explored at the |
| | point before input | point before input | point before input |
| | mapping if the next | mapping. | mapping |
| | element is an activity | | |
| | element or an intermediate | | |
| | event. | | |
| | If the next element | | |
| | is an end event, the | | |
| | element will be explored | | |
| | at the point before output | | |
| | mapping. | | |

Table 2 below describes the effect of selecting each of three commands on a start or intermediate event of the business process depending whether the command reaches the event at the point before output mapping or in the stage after output mapping.

TABLE 2

| Start/Intermediate | | | |
|---|---|---|---|
| Event | Step Into | Step Over | Step Return |
| Response to command | If the step into command | If the step over command | If the step return command |
| depending on element and | is chosen on a start event | is chosen on a start event | is chosen on an activity |
| point of execution of | or an intermediate | or an intermediate event | element which is at the |
| the business process. | event which is at the | which is at the point | point before output |
| | point before output | before output mapping, the | mapping, the execution of |
| | mapping, the next element | next element will be | the business process will |
| | will be explored at the | explored at the point | be resumed and suspended |
| | point before input | before input mapping if | on the next element at the |
| | mapping. | the next element is an | point before input |
| | | activity element, a start | mapping. |
| | | event, or an intermediate | |
| | | event. | |
| | | If the next element | |
| | | is an end event, the | |
| | | element will be explored | |
| | | at the point before output | |
| | | mapping. | |
| Response to command | If the step into command | If the step over command | This command is not |
| depending on element and | is chosen on a start event | is chosen on a start event | available for a start or |
| point of execution of | or an intermediate event | or an intermediate event | intermediate event at the |
| the business process. | which is at the point | which is at the point | point after output |
| | after output mapping, the | after output mapping, the | mapping. |
| | next element will be | next element will be | |
| | explored at the point | explored at the point | |
| | before input mapping if | before input mapping if | |
| | the next element is an | the next element is an | |
| | activity element. | activity element, a start | |
| | If the | event, or an intermediate | |
| | next element is an end | event. | |
| | event, the element will be | If the next element | |
| | explored at the point | is an end event, the | |
| | before output mapping. | element will be explored | |
| | | at the point before output | |
| | | mapping. | |

Table 3 below describes the effect of selecting each of three commands on an end event of the business process depending if the option reaches the event at the point before input mapping or in the stage after input mapping.

TABLE 3

| End Event | Step Into | Step Over | Step Return |
|---|---|---|---|
| Response to command | If the step into command | If the step over command | This command is not |
| depending on element and | is chosen on an end event | is chosen on an end event | available for an end event |
| point of execution of | which is at the point | at the point before input | at point before input |
| the business process. | before input mapping, the | mapping, the debugging of | mapping. |
| | next element will be | the business process is | |
| | explored at the point | terminated. | |
| | before input mapping. | | |
| Response to command | If the step into command | If the step over command | This command is not |
| depending on element and | is chosen on an end event | is chosen on an end event | available for an end event |
| point of execution of | at the point after input | at the point after input | at point after input |
| the business process. | mapping, the debugging of | mapping, the debugging of | mapping. |
| | the business process is | the business process is | |
| | terminated. | terminated. | |

In an exemplary embodiment and exemplary system described herein, a user may choose to explore a sub-process of a business process. Table 4 below describes the effect of selecting each of three commands on a sub-process of the business process.

TABLE 4

| Sub-process | Step Into | Step Over | Step Return |
|---|---|---|---|
| Response to command | If a step into command is | If the step over command | If the step return command |
| depending on element and | chosen on a sub-process | is chosen on a sub-process | is chosen on a sub process |
| point of execution of | element, at the point into | element, at the point into | element at the point into |
| the business process. | subflow, the first sub- | subflow, the next element | subflow, the parent |
| | element of the sub-process | will be explored at the | element of the sub-process |
| | will be explored at the | point before input mapping | element will be explored |
| | point before output | if the next element is an | at the point out subflow. |
| | mapping. | activity element or an end | |
| | | event. | |
| | | If the next element | |
| | | is an end event, the | |
| | | element will be explored | |
| | | at the point before output | |
| | | mapping. | |
| Response to command | If the step into command | If the step over command | This command is not |
| depending on element and | is chosen on a sub-process | is chosen on a sub-process | available for a sub- |
| point of execution of | element, at the point into | element, at the point into | process element at the |
| the business process. | subflow, the next element | subflow, the next element | point out subflow. |
| | will be explored at the | will be explored at the | |
| | point before input mapping | point before input mapping | |
| | if the next element is an | if the next element is an | |
| | activity element or an end | activity element or an end | |
| | event. | event. | |
| | If the next element | If the next element | |
| | is an end event, the | is an end event, the | |
| | element will be explored | element will be explored | |
| | at the point before output | at the point before output | |
| | mapping. | mapping. | |

Referring to Table 4 above, via the ‘step into’ command, the user may examine the complete subflow of the sub-process. Using the ‘step over’ command, the user may navigate the debugging to the next object in the outer business process (that is, the parent of the sub-process).

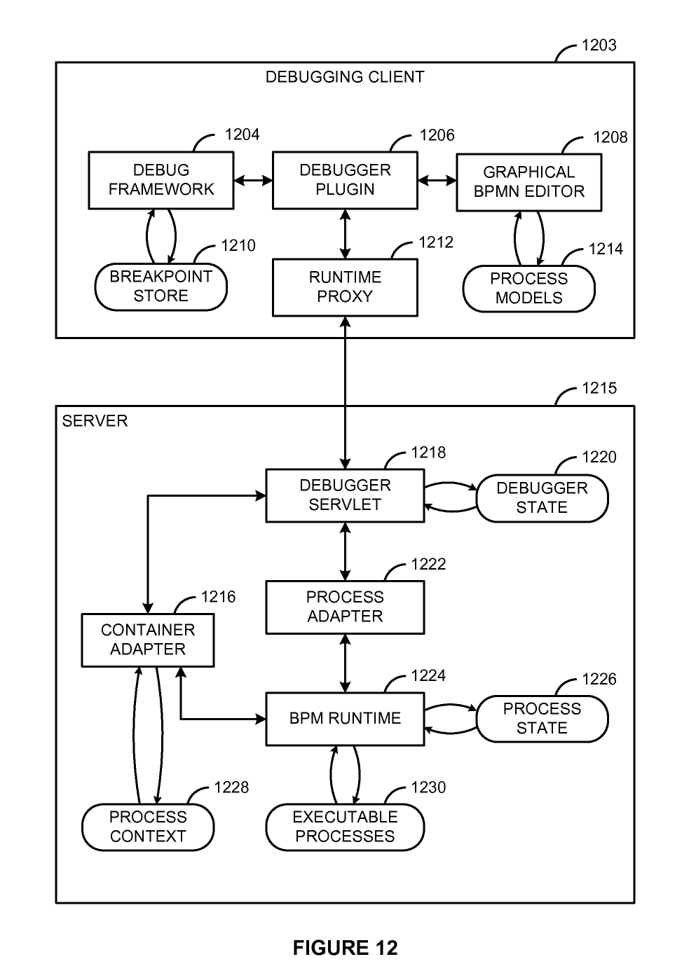

FIG. 12 is a block diagram of a system of an embodiment for debugging a business process. Referring to FIG. 12, a debugging client 1203 interacts with a server 1215 to execute a business process and debug the business process. Breakpoints are created on the business process model in the graphical business process editor (BPMN editor) 1208. The graphical business process editor 1208 displays the graphical elements of the business process using model elements stored in the process models store 1214. The set of breakpoints are stored in the breakpoint store 1210 via the debugger plugin module 1206 and the debug framework 1204. The debugging client 1203 interfaces with the server 1215 via the runtime proxy module 1212 over a communication protocol. In one embodiment, the Hyper Text Transfer Protocol (“HTTP”) may be used as the communication protocol. In various embodiments, other protocols may be used.

The server 1215 executes the debugging of the business process via the debugger servlet 1218, which obtains debugging information from the business process (BPM) runtime 1224 via the process adapter 1222. The debugger servlet stores a debugging state in the debugger state module 1220.

The business process runtime 1224 stores deployed business processes in the executable processes store 1230. The business process runtime 1224 also stores states of business processes in the process state store 1226. The debugger servlet 1218 and the business process runtime 1224 obtain context information for the business process via the container adapter module 1216 from the process context module 1228.

In one embodiment, the communication between the server 1215 and the debugging client 1203 is conducted remotely. In another embodiment, the communication between the server 1215 and the debugging client 1203 is conducted locally, that is, both the server 1215 and the debugging client 1203 are running on the same machine.

Table 5 below describes the available commands on a communication protocol between a client and a server in one exemplary embodiment.

TABLE 5

| Command | Description of command |
|---|---|
| getWorkflowInstances | Using this command, the deployed |
| | instances of business processes are |
| | obtained. |
| attachDebugger | Using this command, a debugger is |
| | attached to a business process. |
| addBreakpoint | Using this command, received breakpoints |
| | are attached to a deployed business process. |
| removeBreakpoint | Using this command, a breakpoint may be |
| | deleted. |
| resumeExecution | Using this command, a next breakpoint |
| | may be reached. |
| getProcessContext | Using this command, a business process |
| | context may be obtained. |
| detachDebugger | Using this command, a debugger is |
| | detached from a business process. |
| getWorkflowInstances | Using this command, a server may confirm |
| | a business process is deployed. |
| attachDebugger | Using this command, it can be identified if |
| | an attach is successful or not successful. |
| tokenChange | Using this command, a created or deleted |
| | token is identified. |
| addBreakpoint | Using this command, breakpoint is added. |
| removeBreakpoint | Using this command, breakpoint is deleted. |
| reportStop | Using this command, the execution of a |
| | business process is suspended upon |
| | reaching a breakpoint. |

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components may be implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable medium as instructions. The term “computer readable medium” should be taken to include a single medium or multiple media that stores one or more sets of instructions. The term “computer readable medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer-readable media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the may be implemented using Java, C++, or other object-oriented programming language and development tools. Another embodiment may be implemented in hard-wired circuitry in place of, or in combination with machine readable software instructions.

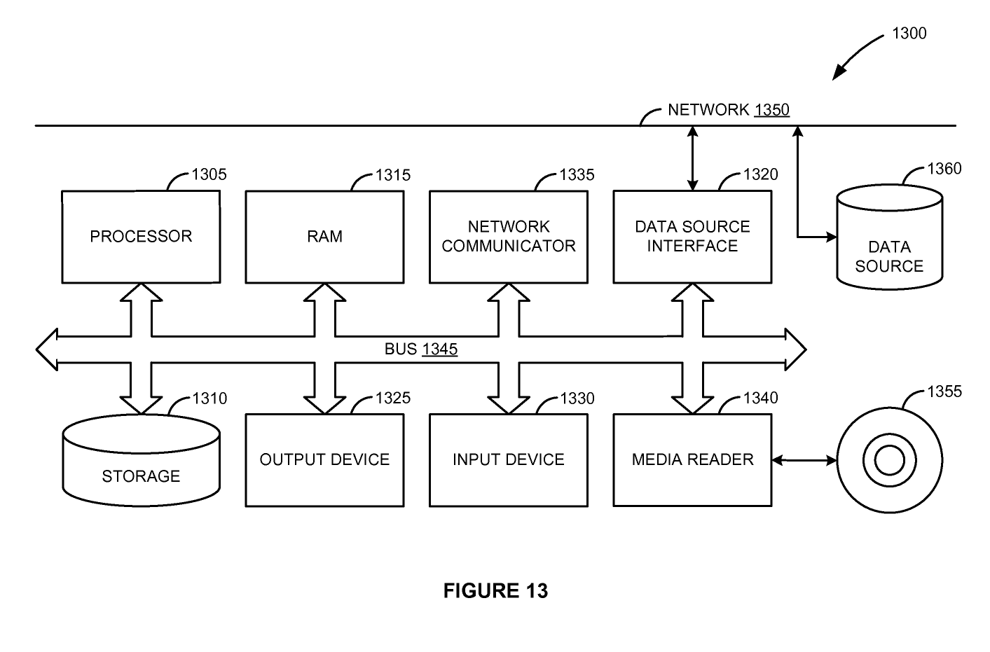

FIG. 13 is a block diagram of an exemplary computer system 1300. The computer system 1300 includes a processor 1305 that executes software instructions or code stored on a computer readable medium 1355 to perform the above-illustrated methods. The computer system 1300 includes a media reader 1340 to read the instructions from the computer readable medium 1355 and store the instructions in storage 1310 or in random access memory (RAM) 1315. The storage 1310 provides a large space for keeping static data where at least some instructions could be stored for later execution. The stored instructions may be further compiled to generate other representations of the instructions and dynamically stored in the RAM 1315. The processor 1305 reads instructions from the RAM 1315 and performs actions as instructed. According to one embodiment, the computer system 1300 further includes an output device 1325 (e.g., a display) to provide at least some of the results of the execution as output including, but not limited to, visual information to users and an input device 1330 to provide a user or another device with means for entering data and/or otherwise interact with the computer system 1300. Each of these output 1325 and input devices 1330 could be joined by one or more additional peripherals to further expand the capabilities of the computer system 1300. A network communicator 1335 may be provided to connect the computer system 1300 to a network 1350 and in turn to other devices connected to the network 1350 including other clients, servers, data stores, and interfaces, for instance. The modules of the computer system 1300 are interconnected via a bus 1345. Computer system 1300 includes a data source interface 1320 to access data source 1360. The data source 1360 can be accessed via one or more abstraction layers implemented in hardware or software. For example, the data source 1360 may be accessed by network 1350. In some embodiments the data source 1360 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, one or more reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. A machine-readable storage device having machine readable instructions tangibly stored thereon which when executed by the machine, cause the machine to perform a method related to debugging of a business process in a Graphical User Interface (GUI), the method comprising:
attaching one or more breakpoints to one or more elements of the business process;
executing the business process with one or more debugging initiation parameters related to the business process;
sending one or more context parameters related to the business process to the GUI responsive to reaching one of the one or more elements with one of the one or more breakpoints; and
receiving one or more navigation commands to navigate through the business process from the GUI.

2. The machine-readable storage device of claim 1, wherein the one or more navigation commands include:
a first command to resume the executing of the business process;
a second command to reach an element of the business process subsequent to the one of the one or more breakpoints and add a temporary breakpoint;
a third command to resume the executing of the business process if no other of the one or more breakpoints are reached on the one of the one or more elements; and
a forth command to resume the debugging of the business process inside the one of the one or more elements.

3. The machine-readable storage device of claim 1, wherein attaching the one or more breakpoints to the business process comprises:
determining one or more breakpoints in a model of the business process in the GUI, wherein at each of the one or more breakpoints execution of the business process is interrupted; and
associating the one or more breakpoints to the one or more elements of the business process.

4. The machine-readable storage device of claim 1, wherein the method further comprises initiating the debugging of the business process, wherein initiating comprises:
confirming the business process is deployed;
generating a debugging identifier; and
generating one or more breakpoint identifiers for the one or more breakpoints.

5. The machine-readable storage device of claim 1, wherein the method further comprises terminating the debugging of the business process, wherein terminating comprises:
identifying a debugging ID;
removing the one or more breakpoints related to the business process; and
confirming the debugging of the business process with the identified ID is stopped.

6. The machine-readable storage device of claim 1, wherein sending one or more context parameters related to the business process to the GUI comprises:
suspending the business process responsive to reaching one of the one or more breakpoints;
receiving one or more context parameter values related to the one of the one or more breakpoints; and
translating the one or more context parameter values to one or more elements in the GUI.

7. The machine-readable storage device of claim 1, wherein the method further comprises:
creating an input data breakpoint to examine a set of input data related to the one of the one or more elements of the business process, wherein the input data breakpoint is created on demand responsive to receiving a request for the examination of the set of input data related to the one of the one or more elements of the business process;
displaying the set of input data in the GUI; and
terminating the input data breakpoint.

8. The machine-readable storage device of claim 1, wherein the method further comprises:
creating an output data breakpoint to examine a set of output data related to the one of the one or more elements of the business process, wherein the output data breakpoint is created on demand responsive to receiving a request from a user for the examination of the set of output data related to the one of the one or more elements of the business process;
displaying the set of output data in the GUI; and
terminating the output data breakpoint.

9. The machine-readable storage device of claim 1, wherein the method further comprises selecting one or more debugging modes, including:
a debugging mode to debug a single business process instance; and
a debugging mode to debug one or more business process instances.

10. The machine-readable storage device of claim 1, further comprising instructions for iteratively suspending the debugging of the business process, sending context parameters to the GUI, and resuming the debugging of the business process responsive to reaching each of the one or more breakpoints.

11. A computerized system including a processor, the processor communicating with one or more memory devices storing instructions, the instructions comprising:
a debugging client, the debugging client including:
a debug module to receive one or more breakpoints from a debug framework; and
a graphical business process editor to receive debugging information related to a business process from the debug framework and to display debugging information in one or more graphical elements; and
a server runtime environment to debug the business process, the server runtime environment including:
a debugger servlet to receive the debugging information from a business process runtime module via a process adapter and to store a debugging state in a debugger state module; and
a container adapter module to provide a business process context of the business process from a process context module to the debugger servlet.

12. The system of claim 11, wherein the debugging client further comprises:
a breakpoint store to store the one or more breakpoints;
a process models store to store one or more business process models for the graphical business process editor; and
a runtime proxy module to connect the debugging client to the server runtime environment via a communication protocol.

13. The system of claim 11, wherein the server runtime environment further comprises:
an executable processes store to store one or more business processes deployed on the server runtime environment; and
a process state store to store a state of the business process.

14. A computerized method, comprising:
receiving a first plurality of commands, the first plurality of commands to generate one or more breakpoints in a GUI on one or more elements related to a model of a business process,
displaying one or more business process context parameters on the one or more elements related to the model of the business process in the GUI; and
receiving a second plurality of commands to navigate through the one or more elements related to the business process model, wherein the second plurality of commands include:
a resume command to resume an execution of the business process model;
a step over command to move from the one of the one or more elements to a subsequent element from the one or more elements, wherein a temporary breakpoint is generated responsive to the step over command;
a step into command to initiate a debugging of one or more sub-elements of the one of the one or more elements; and
a step return command to resume a debugging of the one of the one or more elements after the debugging of the one or more sub-elements.

15. The computerized method of claim 14, wherein the one or more elements are generated according to one or more business process modeling notations.

16. The computerized method of claim 14, further comprising receiving a command to initiate a debugging of the business process responsive to receiving the first plurality of commands.

17. The computerized method of claim 14, wherein displaying the one or more business process context parameters comprises:
receiving the one or more business process context parameters responsive to reaching one of the one or more breakpoints on one of the one or more elements;
converting the one or more business process context parameters to a graphical format; and
attaching each of the one or more business process context parameters to one or more GUI elements.

18. The computerized method of claim 14, further comprising receiving a command to terminate a debugging of the business process.

19. The computerized method of claim 14, wherein receiving the first plurality of commands comprises:
capturing the first plurality of commands in GUI elements; and
converting the first plurality of commands to a serializable format.

20. The computerized method of claim 13, wherein receiving the second plurality of commands comprises:
capturing the second plurality of commands in GUI elements; and
converting the second plurality of commands to a serializable format.
